(19) United States
(12) Patent Application Publication
(10) Pub. No.: US 2006/0020903 A1
(43) Pub. Date: Jan. 26, 2006

(54) Window split system and method

(76) Inventors: Shih-Yang Wang, Taipei (TW); Louis Yen, Taipei (TW)

Correspondence Address: BIRCH STEWART KOLASCH & BIRCH, PO BOX 747, FALLS CHURCH, VA, 22040-0747, US

(21) Appl. No.: 10/898,349

(22) Filed: Jul. 26, 2004

(51) Int. Cl. G06F 17/00

(52) U.S. Cl. 715/792

(57) ABSTRACT

A window split system and method. The window split system includes a window, a splitter, and a module. The splitter is set on the window to split the window into a first part and a second part according to the split direction and the position of the splitter. The module changes the split direction of the splitter in response to a direction, such that the window is then split by the splitter in the changed split direction. The split direction is changed if the splitter touches the border of the window, if the splitter is double clicked by a pointing device, and if a control object connected to the end of the splitter and set around the border of the window moves across the corner of the window.

### BACKGROUND OF THE INVENTION

1. Field of the Invention

The present invention relates to the display of windows in a computer environment, and particularly to a window split system and method, and application program interfaces capable of changing the split direction of a window.

2. Description of the Related Art

Graphical user interfaces (GUI) have become well known by computer users and are incorporated in many computer systems and computer operating systems. In general, a GUI operating environment can be thought of as an end user environment that is graphical, such that the end user interfaces with the environment via a variety of elements on a display screen including windows, icons, menus, pointing devices, and others.

A common feature of GUI systems is that a multitude of windows or views can be present simultaneously on the computer display screen. Different application programs can be executing concurrently in each of the windows displayed on the screen. The user can use a mouse or other input device to move back and forth between different windows, thereby making it possible to perform many different tasks.

Additionally, one application program can perform different functions in each of the windows displayed on the screen. For example, a split view of an image 110 is illustrated in FIG. 1. As in FIG. 1, a window 100 displays the image 110. The image 110 is split into a right sub-image 111 and a left sub-image 112 by a splitter 101. The splitter 101 can be dragged to adjust the size of the right sub-image 111 and the left sub-image 112. The right sub-image 111 corresponds to the right part of the original image 110. The left sub-image 112 corresponds to the left part of the original image 110 with a mask effect applied. Since the splitter 101 is vertical, it is suitable for transverse images, such as landscapes. For vertical images, such as portraits, the images can be split into upper and lower views. Conventional systems and methods are capable of vertical window splits, but, lack the ability to switch and change the window split direction.

### SUMMARY OF THE INVENTION

It is therefore an object of the present invention to provide a window split system and method capable of changing the split direction of a window.

To achieve the above object, the present invention provides a window split system and method. According to one embodiment of the invention, a window split system includes a window, a splitter, and a module. The splitter is set on the window to split the window into a first part and a second part according to the split direction and the position of the splitter. The module changes the split direction of the splitter in response to a direction, such that the window is then split by the splitter in the changed split direction.

The split direction is changed if the splitter touches the border of the window, or if the splitter is double clicked by a pointing device.

The system further comprises a control object connected to the end of the splitter and set around on the border of the window to control the position of the splitter, and the split direction is changed if the control object moves across the corner of the window.

The system further comprises an image displayed in the window. The image is split into a first sub-image and a second sub-image displayed in the first part and the second part of the window respectively. The module further applies an image effect on the first sub-image or the second sub-image.

The module further displays different data in the first part and the second part of the window respectively.

According to another embodiment of the invention, a window split method is provided. First, a window is split into a first part and a second part by a splitter set on the window according to the split direction and the position of the splitter. Then, the split direction is changed in response to a direction, such that the window is then split by the splitter in the changed split direction.

The split direction is changed if the splitter touches the border of the window, or if the splitter is double clicked by a pointing device.

The split direction is changed if a control object connected to the end of the splitter and set around the border of the window moves across the corner of the window.

An image is further displayed in the window. The image is split into a first sub-image and a second sub-image displayed in the first part and the second part of the window respectively. An image effect is further applied on the first sub-image or the second sub-image.

Different data is further displayed in the first part and the second part of the window respectively.

The above-mentioned method may take the form of program code or application program interfaces embodied in tangible media. When the program code is loaded into and executed by a machine, the machine becomes an apparatus for practicing the invention.

### BRIEF DESCRIPTION OF THE DRAWINGS

The aforementioned objects, features and advantages of the invention will become apparent by referring to the following detailed description with reference to the accompanying drawings, wherein:

FIG. 1 shows a conventional split view;

FIG. 2 is a schematic diagram illustrating the components of a window split system according to a first embodiment of the present invention;

FIG. 3 shows an example of size adjustment for split window according to the first embodiment of the present invention;

FIG. 4 shows an operation for changing the split direction according to the first embodiment of the present invention;

FIG. 5 shows split windows after a split direction change according to the first embodiment of the present invention;

FIG. 6 is a schematic diagram illustrating the components of the window split system according to a second embodiment of the present invention;

FIG. 7 shows an example of size adjustment for a split window according to the second embodiment of the present invention;

FIG. 7A shows the control object dragged across the corner of the window;

FIG. 8 shows split windows after a split direction change according to the second embodiment of the present invention;

FIG. 9A shows an example of a split view;

FIG. 9B shows the split view in FIG. 9A with size adjustment;

FIG. 9C shows a new split view after a split direction change;

FIG. 10 is a flowchart showing a window split method according to the present invention;

FIG. 11 is a schematic diagram illustrating a storage medium for storing a computer program for execution of the window split method according to the present invention;

FIG. 12A shows the splitter with double click; and

FIG. 12B shows the changed split direction after the splitter is double clicked.

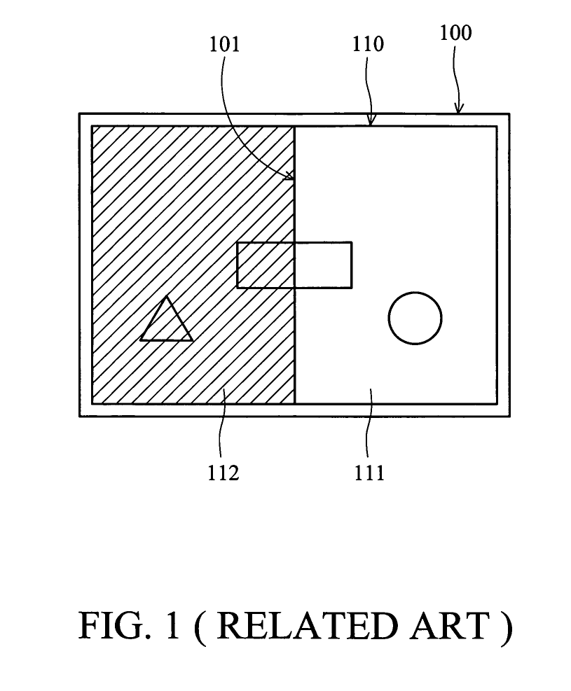

### DETAILED DESCRIPTION OF THE INVENTION

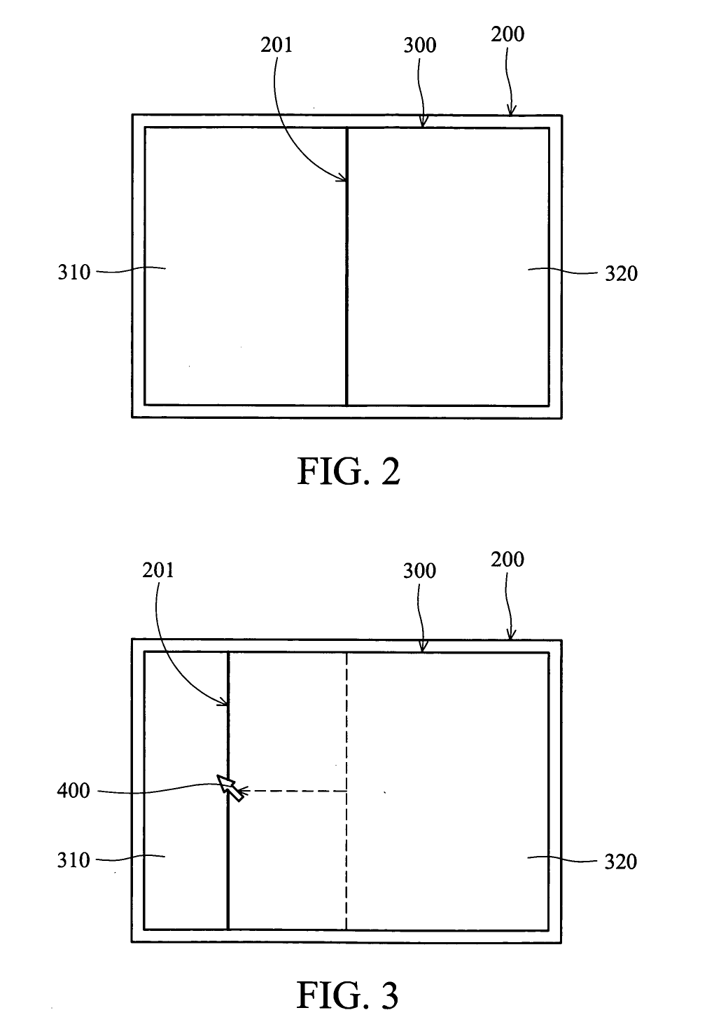

FIG. 2 is a schematic diagram illustrating the components of a window split system according to a first embodiment of the present invention. The window split system includes at least one application program interface including a window 200 and a splitter 201, and a module (not shown) performing a split direction change according to the present invention.

The splitter 201 splits the window 200 into a first part and a second part in a split direction (vertical in FIG. 2). It is understood that the module performs the window split according to the position of the splitter 201 and the split direction. An image 300 can be split by the splitter 201 into a first sub-image 310 and a second sub-image 320 displayed in the first part and the second part of the window 200 respectively. It is also understood that the window 200 may be a window defined in Window systems or a frame for displaying one image. The splitter 201 may be represented as a slider, and can be dragged using a pointing device 400, such as a mouse as shown in FIG. 3. Once the splitter 201 is dragged, the module records the location of the splitter 201, and adjusts the size of each split window (the first and second parts) synchronously. It is understood that the range of respective first and second sub-images is simultaneously adjusted.

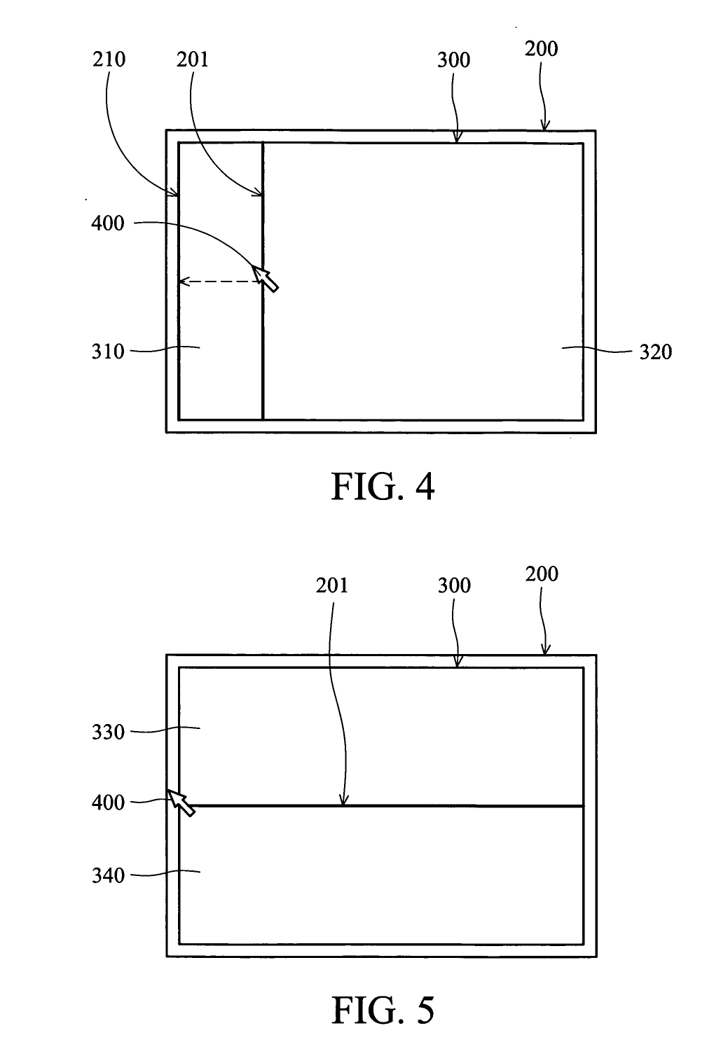

In the first embodiment, the present invention provides three manners of directing the split direction change. First, the splitter 201 can be dragged by the pointing device 400 to close the border 210 of the window 200 as shown in FIG. 4. Once the splitter 201 touches the border 210, the module records the touched position of the pointing device 400, and changes the split direction of the splitter 201 from vertical to horizontal according to the touched position of the pointing device 400 as shown in FIG. 5. After a split direction change, the window 200 is then split into an upper part and a lower part, and the image 300 is split into an upper sub-image 330 and a lower sub-image 340.

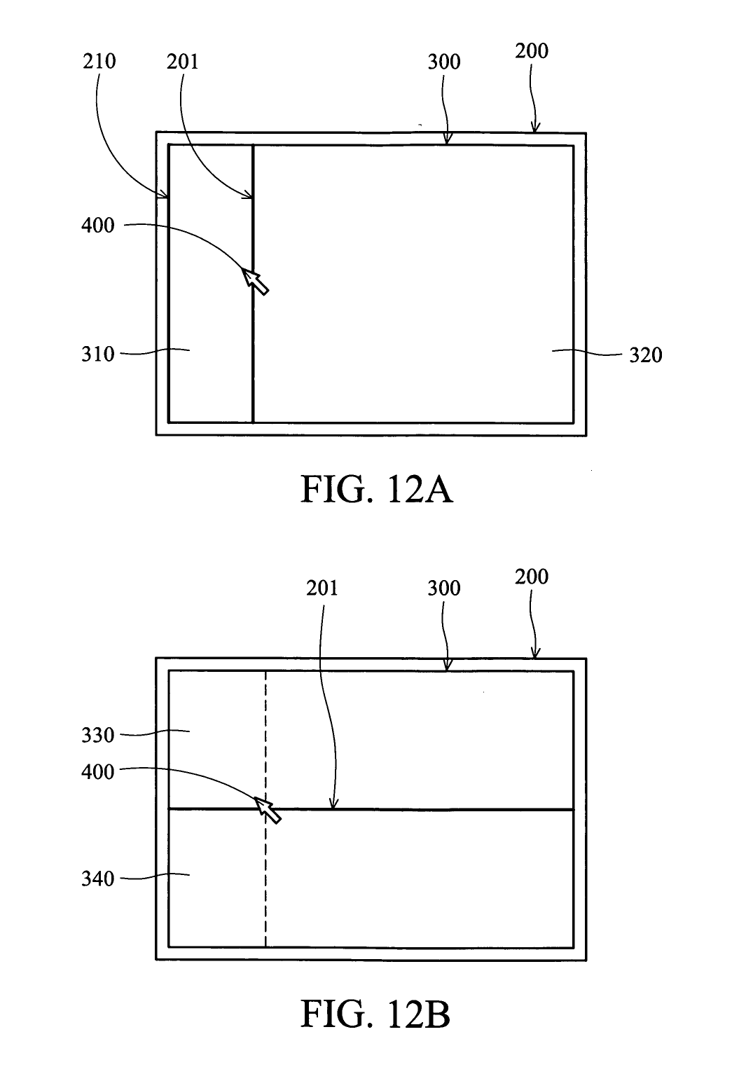

Second, the splitter 201 can be double clicked by the pointing device 400 as shown in FIG. 12A. Once the splitter 201 is double clicked, the module records the clicked position of the pointing device 400, and changes the split direction of the splitter 201 from vertical to horizontal according to the clicked position of the pointing device 400 as shown in FIG. 12B. Third, an icon designed as a GUI object (not shown) can be further provided in the application program interface of the present invention. The icon symbolically represents a variety of operations the computer system will execute when the icons are chosen. Once the icon is chosen, the module immediately changes the split direction and sets the splitter 201 at a predetermined position.

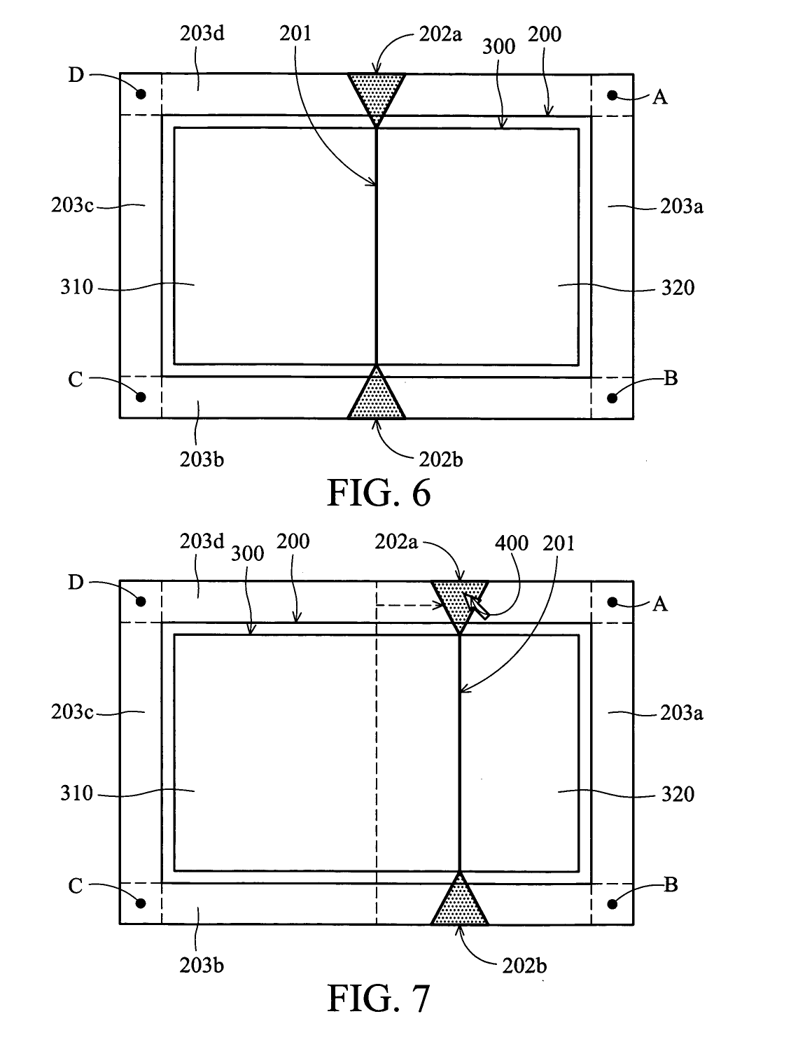

FIG. 6 is a schematic diagram illustrating the components of the window split system according to a second embodiment of the present invention. Similar components in the first and second embodiments are referred to using like designations. The window split system includes at least one application program interface including a window 200, a splitter 201, control objects 202a and 202b, and a module (not shown) performing split direction changes according to the present invention.

The control objects 202a and 202b can be represented as scroll wheels connected to the ends of the splitter 201 to control the position of the splitter 201. Four scroll wheel windows 203a, 203b, 203c and 203d are connected and set around the border of the window 200. The control objects 202a and 202b can slide within the scroll wheel windows. Additionally, four articulation points A, B, C and D are set between these scroll wheel windows. The use of these articulation points will be introduced later.

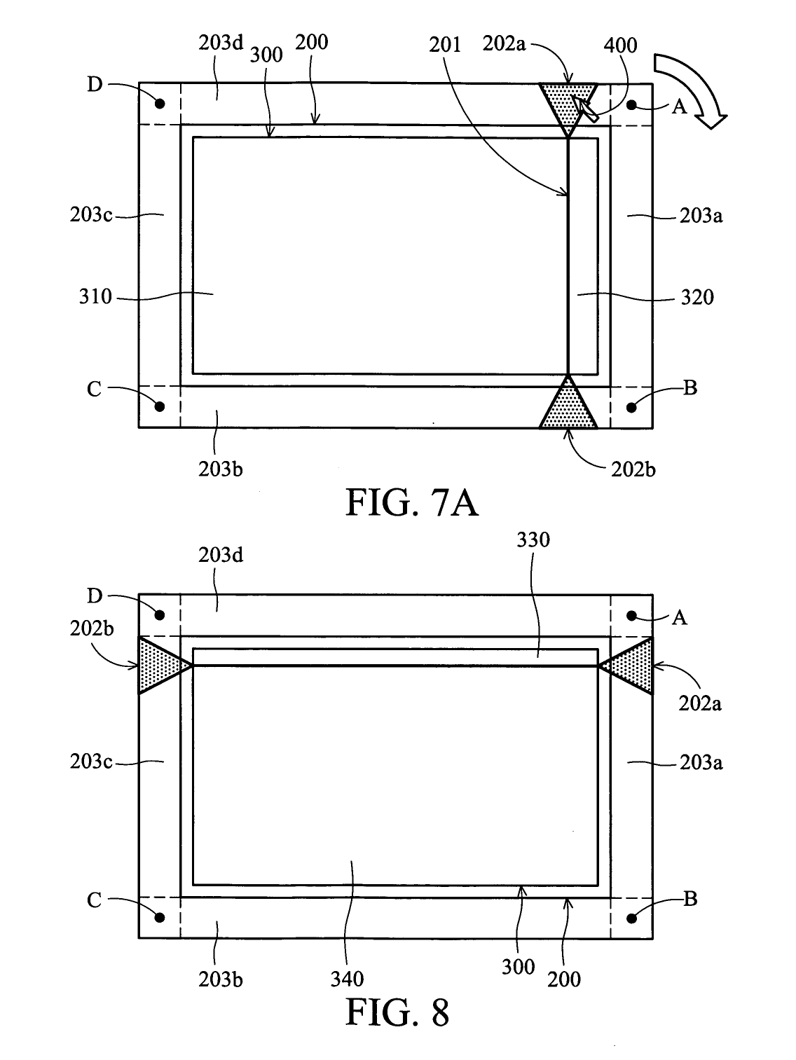

Similarly, the splitter 201 splits the window 200 into a first part and a second part in a split direction (vertical in FIG. 6). An image 300 can be split by the splitter 201 into a first sub-image 310 and a second sub-image 320 displayed in the first part and the second part of the window 200 respectively. The control object 202a (or 202b) can be dragged using a pointing device 400 as shown in FIG. 7. Once the control object 202a is dragged, the module records the location of the control object 202a or the splitter 201. It is understood that the splitter 201 moves correspondingly with the control object 202a. The module then adjusts the size of each split window (the first and second parts) synchronously. Similarly, the range of respective first and second sub-images is simultaneously adjusted.

In addition to the manners introduced in the first embodiment, the present invention provides another manner of directing the split direction change in the second embodiment. The control object can be dragged by the pointing device 400 across the corner of the window as shown in FIG. 7A. Once the control object moves across the articulation points A, B, C and D, the module records the position of the pointing device 400, and changes the split direction of the splitter 201 according to the position of the control object. For example, the split direction is changed from vertical to horizontal as shown in FIG. 8. After a split direction change, the window 200 is then split into an upper part and a lower part, and the image 300 is split into an upper sub-image 330 and a lower sub-image 340.

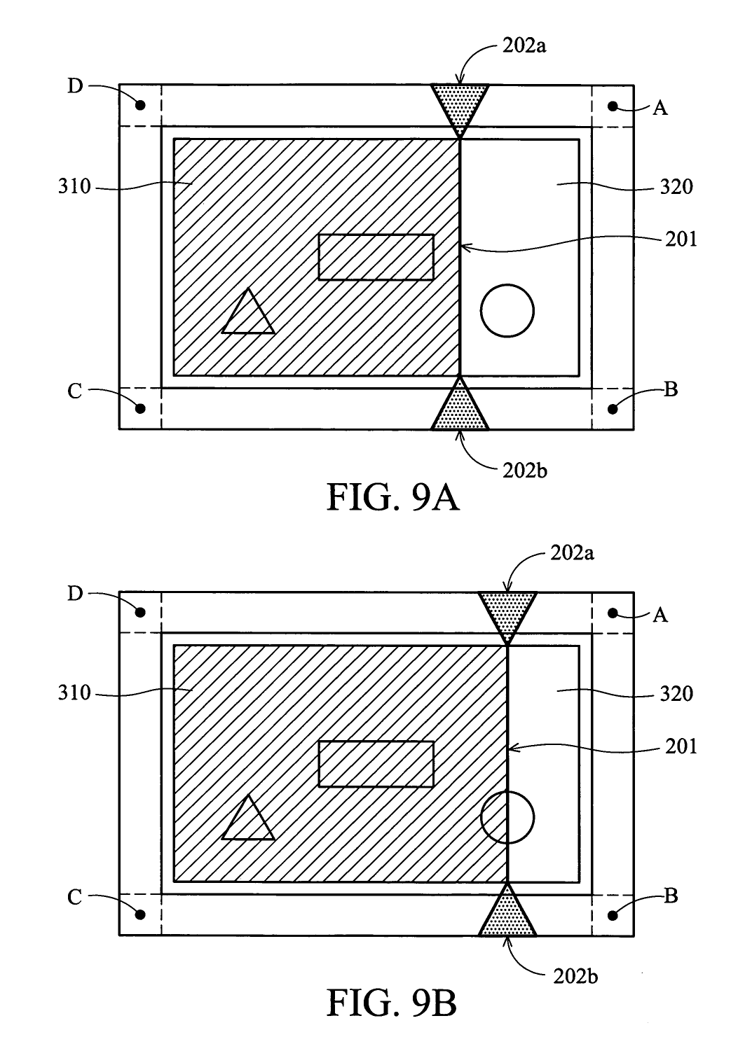

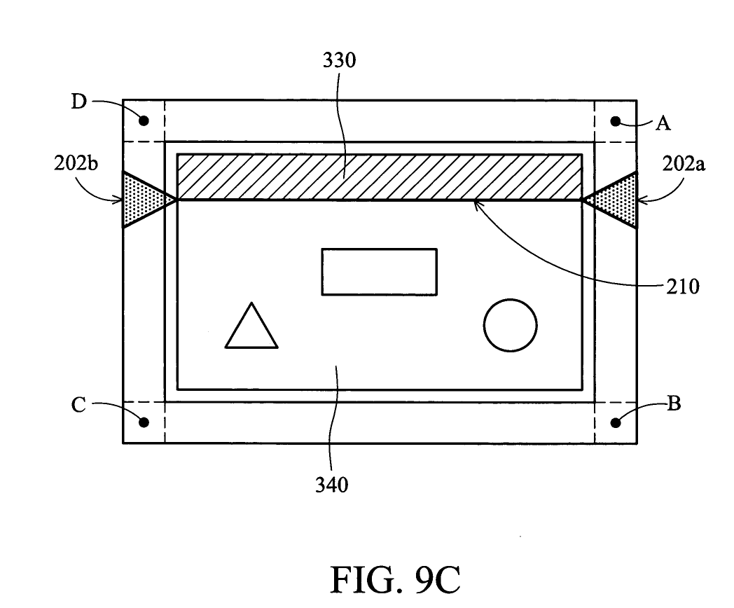

In the present invention, the split windows may be independent windows displaying different data. Additionally, the split windows may be one relative window. FIG. 9A shows an example of a split view. In FIG. 9A, the module applies an image effect, such as a mask effect on the first sub-image 310, and keeps the second sub-image 320 corresponding to the right part of the original image. It is understood that the mask effect may be also applied on the second sub-image 320. Similarly, the range of the first and second sub-images can be adjusted by dragging the control objects 202a and 202b or the splitter 201 as shown in FIG. 9B. If the direction of the split view is required to change, the control objects 202a and 202b can be dragged across the corner of the window 200. Once the control objects 202a and 202b are dragged across the corner of the window 200, the split direction of the splitter 201 is changed from vertical to horizontal as shown in FIG. 9C. The image 300 is split into the upper sub-image 330 with a mask effect and a lower sub-image 340 without the effect.

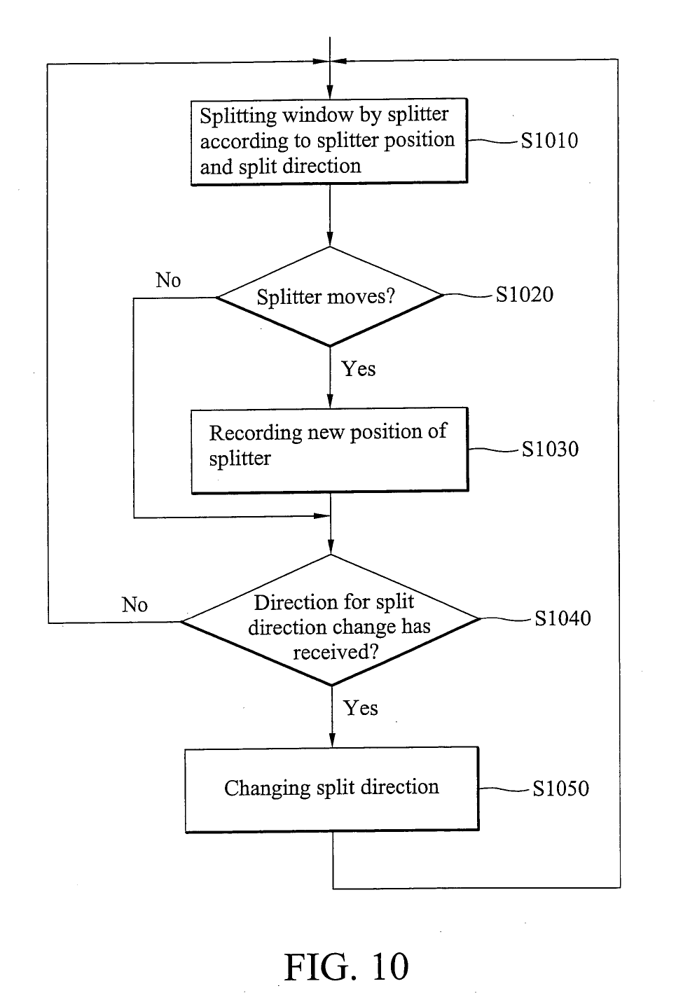

FIG. 10 is a flowchart showing a window split method according to the present invention.

First, in step S1010, a window is split into a first part and a second part by a splitter according to a split direction and the position of the splitter. Then, in step S1020, it is determined whether the splitter has moved. If no (No in step S1020), the procedure proceeds to step S1040. If yes (Yes in step S1020), in step S1030, the new position of the splitter is recorded. Then, in step S1040, it is determined whether a direction for a split direction change has been received. If no (No in step S1040), the procedure returns to step S1010. If yes (Yes in step S1040), in step S1050, the split direction of the splitter is changed in response to the direction. Thereafter, the procedure returns to step S1010, such that the window is then split by the splitter in the changed split direction. It is understood that if the splitter has moved, the window is split according to the new position of the splitter.

It is also understood that the direction for split direction change may be the operations described in the first and second embodiments. For example, the operations comprise the splitter being dragged to touch the border of the window, the splitter being double clicked by a pointing device, the button for split direction change being chosen, and the control object connected to the end of the splitter being dragged across the corner of the window.

Additionally, an image is further displayed in the window. The image is split into a first sub-image and a second sub-image displayed in the first part and the second part of the window respectively. An image effect is further applied on the first sub-image or the second sub-image. Further, different data can be displayed in the first part and the second part of the window respectively.

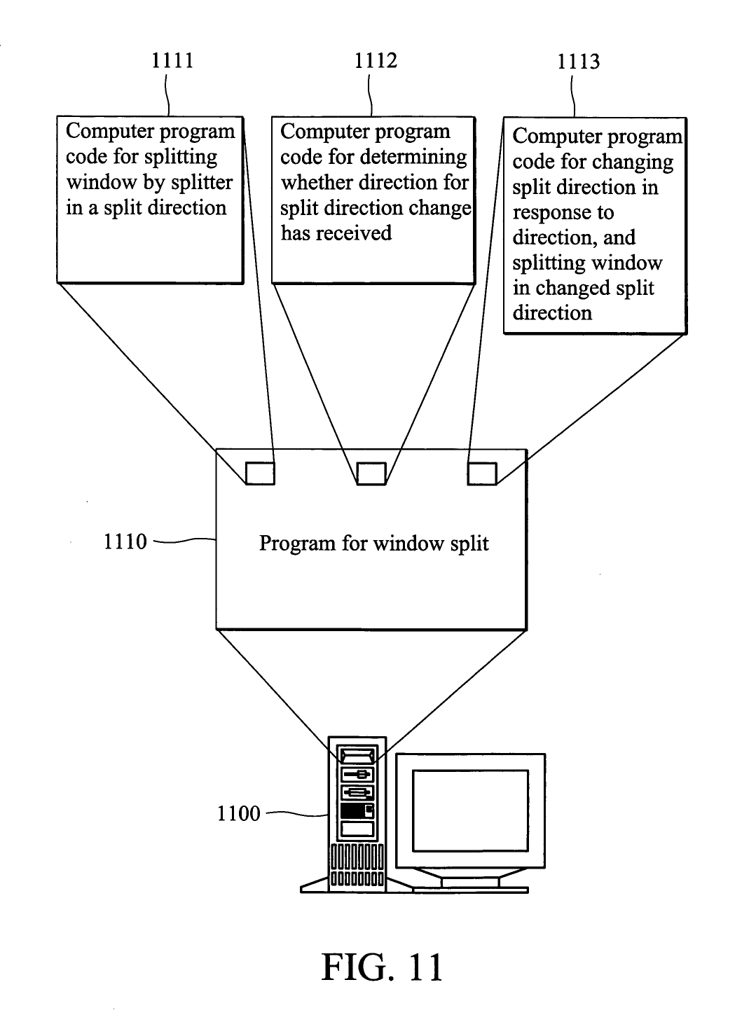

FIG. 11 is a diagram of a storage medium for storing a computer program providing the window split method according to the present invention. The computer program product comprises a storage medium 1110 having computer readable program code embodied in the medium for use in a computer system 1100, the computer readable program code comprises at least computer readable program code 1111 splitting a window into a first part and a second part by a splitter set on the window in a split direction, computer readable program code 1112 determining whether a direction for a split direction change has been received, and computer readable program code 1113 changing the split direction in response to a direction, such that the window is split by the splitter in the changed split direction.

The present invention thus provides a window split system and method, and application program interfaces capable of changing the split direction of a window, thereby improving the functionality of split view and window split systems.

The method and system of the present invention, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The method and systems of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to application specific logic circuits.

Although the present invention has been described in its preferred embodiments, it is not intended to limit the invention to the precise embodiments disclosed herein. Those skilled in this technology can still make various alterations and modifications without departing from the scope and spirit of this invention. Therefore, the scope of the present invention shall be defined and protected by the following claims and their equivalents.

What is claimed is:

1. A window split system, comprising:
a window;
a splitter set on the window to split the window into a first part and a second part in a split direction; and
a means for changing the split direction in response to a direction, such that the window is split by the splitter in the changed split direction.

2. The system of claim 1 wherein the split direction is changed if the splitter touches the border of the window.

3. The system of claim 1 wherein the split direction is changed if the splitter is double clicked by a pointing device.

4. The system of claim 1 further comprising a control object connected to the end of the splitter and set around on the border of the window to control the position of the splitter.

5. The system of claim 4 wherein the split direction is changed if the control object moves across the corner of the window.

6. The system of claim 1 wherein the window is split according to the split direction and the position of the splitter.

7. The system of claim 1 further comprising an image displayed in the window, wherein the image is split into a first sub-image and a second sub-image displayed in the first part and the second part of the window respectively.

8. The system of claim 7 further comprising a means for applying an image effect on the first sub-image or the second sub-image.

9. The system of claim 1 further comprising a means for displaying different data in the first part and the second part of the window respectively.

10. A window split method, comprising the steps of:
splitting a window into a first part and a second part by a splitter set on the window in a split direction; and
changing the split direction in response to a direction, such that the window is split by the splitter in the changed split direction.

11. The method of claim 10 further comprising changing the split direction if the splitter touches the border of the window.

12. The method of claim 10 further comprising changing the split direction if the splitter is double clicked by a pointing device.

13. The method of claim 10 further comprising changing the split direction if a control object connected to the end of the splitter and set around the border of the window moves across the corner of the window.

14. The method of claim 10 further comprising splitting the window according to the split direction and the position of the splitter.

15. The method of claim 10 further comprising displaying an image in the window, wherein the image is split into a first sub-image and a second sub-image displayed in the first part and the second part of the window respectively.

16. The method of claim 15 further comprising applying an image effect on the first sub-image or the second sub-image.

17. The method of claim 10 further comprising displaying different data in the first part and the second part of the window respectively.

18. A machine-readable storage medium storing a computer program which when executed causes a computer to perform a window split method, the method comprising the steps of:
splitting a window into a first part and a second part by a splitter set on the window in a split direction; and
changing the split direction in response to a direction, such that the window is split by the splitter in the changed split direction.

19. The storage medium of claim 18 wherein the method further comprises changing the split direction if the splitter touches the border of the window or if the splitter is double clicked by a pointing device.

20. The storage medium of claim 18 wherein the method further comprises changing the split direction if a control object connected to the end of the splitter and set around the border of the window moves across the corner of the window.

21. A set of application program interfaces embodied on a computer-readable medium for execution on a computer in conjunction with an application program that performs a window split, comprising:
a first interface to display a window split into a first part and a second part by a splitter set on the window in a split direction, and receive at least one direction enabling the split direction change; and
a second interface to display the window split by the splitter in the changed split direction.

22. The set of application program interfaces of claim 21 wherein the split direction is changed if the splitter touches the border of the window or if the splitter is double clicked by a pointing device.

23. The set of application program interfaces of claim 21 wherein the split direction is changed if a control object connected to the end of the splitter and set around the border of the window moves across the corner of the window.
